(19) United States
(12) Patent Application Publication
(10) Pub. No.: US 2004/0132432 A1
(43) Pub. Date: Jul. 8, 2004

(54) Voice recordal methods and systems

(75) Inventors: Toby Moores, Leicester (GB); Benjamin James Last, Cheshire (GB)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Timeslice Communications Limited, Liverpool (GB)

(21) Appl. No.: 10/677,774

(22) Filed: Oct. 2, 2003

Related U.S. Application Data
(63) Continuation of application No. PCT/GB02/01620, filed on Apr. 5, 2002.

(30) Foreign Application Priority Data
Apr. 5, 2001 (GB) 0108603.2

(51) Int. Cl. H04M 11/10

(52) U.S. Cl. 455/413

(57) ABSTRACT

A method of recording a voice communication between at least two individuals where the two individuals use respective telephone communication devices such as mobile phones to communicate is described. The method comprises: recording at least part of the conversation between the individuals; at least one of the individuals associating one or more tags with selected respective points or portions within the recording, each tag being machine interpretable and indicating a meaning of the respective point or portion within the recording; and storing the recording and tags in a location accessible by at least one of the two individuals. The tags are selected from a plurality of different types of tags each type having a different meaning.

### CROSS-REFERENCE TO RELATED APPLICATIONS

This application is a continuation of International Application No. PCT/GBO2/01620, filed Apr. 5, 2002 and published in English under International Publication No. WO 02/082793 on Oct. 17, 2002, and claims the priority of British Patent Application No. 0108603.2, filed Apr. 5, 2001. The entire disclosure of International Application No. PCT/GBO2/01620 and British Patent Application No. 0108603.2 are incorporated herein by reference.

### FIELD OF THE INVENTION

The present invention concerns improvements relating to methods and systems for voice recordal and provides, more specifically though not exclusively, a method for capturing information which is exchanged during the course of a telephone conversation, such that subsequent retrieval of specific points made during that conversation is facilitated.

### BACKGROUND TO THE INVENTION

In today's world there are many different ways in which we may communicate with those who are remote from us, for example via posted letter, telephone, facsimile, e-mail or text message. However, when important information is to be conveyed, there is a tendency to select a text-based communication method in preference to engaging in verbal communication over the telephone. This preference exists even though matters could often be dealt with more quickly over the telephone. The advantage of text-based communications is, of course, that they provide a record of the information being imparted, whereas the content of a telephone call can be open to dispute and a liability. Indeed, many business-related telephone conversations will simultaneously involve one or both parties making hand-written notes to summarise what is being said in an effort to produce some kind of permanent record. After the conversation is over, these notes may have to be written up into a form legible to others and expanded upon, requiring a dual effort from the communicator. Even when the telephone is used for more informal communication, when useful information such as an address is imparted the recipient will usually need to make a written note to aid their recollection.

The problem of data capture in a telephone call has been addressed previously in various ways, all of which involve some form of voice recordal. For example, an answer phone machine allows a caller to leave a recorded message when the owner is not available to take the call. These machines can also be used to record a conversation between the owner and the caller, although this usually happens inadvertently when the owner fails to stop the machine recording. However, the recording time available for each message is pre-set to be brief for such machines, in accordance with their intended function. Similar problems also apply to the ‘voice memo’ functionality which is now available on many mobile phones, whereby a mobile phone user can cause a voice recorder which is located on the phone to record short parts of a conversation.

The recording of telephone conversations for business purposes has received attention from various sources, ranging from financial trading floors to call centres. The analogue and digital systems employed allow entire conversations to be readily recorded, but often their main purpose is only to provide evidence of who said what in the event of a dispute. Many recordings are therefore rarely utilised. However, certain types of recording can be subjected to intense scrutiny. For example, company results are often reported via telephone conference calls which may last several hours. These recordings are highly populated with facts and analysts must peruse them carefully in order to gauge the performance of the company objectively.

Unfortunately, navigating to a particular point of interest in any lengthy conversation recording is laborious and time-consuming. A user typically experiences considerable difficulty when searching for specific information, often being forced to listen to a large proportion of the conversation. These difficulties may be experienced repeatedly every time the recording is accessed.

Nevertheless, recorded telephone conversations are still considered to be very valuable in certain business areas. This has even lead to mobile recording units being developed for business people to take with them when working off site, despite these devices being cumbersome and inconvenient to use. Of course, recent advances in technology have meant that lengthy recordings are now even possible in the home. Recording capacity can be extended beyond that provided by a basic answer phone by connecting a telephone to a personal computer. However, the navigation problems for longer recordings, as outlined above, remain inherent.

Thus, although the telephone has been known for the last century and a half and its networks now extend to most parts of the world, its limitations as a communications device are readily apparent. This has lead to a move towards more text-based communication and innovation, with e-mail now the favoured means for rapid contact and response. Computers are relatively expensive to manufacture though and so, globally, the number of telephones in use continues to far outweigh the number of computers. Also, whilst large numbers of people remain computer illiterate, most will have access to and be able to use the telephone. Indeed, communication in some countries can be restricted if it is effected by electronic text, since the electronics industry does not cater for every alphabet containing non-alphanumeric characters. Telephones, in comparison, facilitate communication in any language and do not place any restrictions on format. It is, therefore, clear that further value of the telephone as a communications device has yet to be realised.

It is desired to overcome or substantially reduce some of the abovementioned problems. More specifically, it is desired to provide a method of telephone conversation recordal which utilises existing landline and mobile telephones, such that the user may subsequently navigate the recording and return easily to the pertinent points made during the conversation.

### SUMMARY OF THE INVENTION

The present invention resides in the appreciation that the significant benefits of voice communications over text-based communications, outlined above, can be obtained by improving the navigation of recorded voice communications. The simplest way of improving navigation is by the insertion of a structure into a relatively unstructured voice communication such that during playback of the communication, that structure can be used to make the retrieval of specific information from the recording relatively fast and easy.

More specifically, according to one aspect of the present invention there is provided a method of recording a voice communication between at least two individuals where the two individuals use respective telephone communication devices to communicate, the method comprising: recording at least part of the voice communication; at least one of the individuals associating one or more tags with selected respective points or portions within the recording, each tag being machine interpretable and indicating a meaning of the respective point or portion within the recording; and storing the recording and tags in a location accessible by at least one of the two individuals.

Use of the present invention involves individuals holding conversations, or leaving messages for each other, using a communication system which records at least their voices and enables the users to annotate the recordings with tags indicating points or portions of the recordings having particular meanings.

It is to be appreciated that the term ‘within’ as specified in the description and claims is intended to have a literal meaning in that the placing of tags at the beginning and ends of voice recordings, as would be required to distinguish between different recordings, is not covered. This is because the present invention relates to the improved navigation inside the body of a voice communication recording rather than improved navigation between different voice communication recordings.

The insertion of navigation tags within the body of the voice communication by the user enables the user to create their own structure which is commensurate with their understanding of the importance of various sections or points of the voice communication. Thus a user-created structure is usually optimised to the user's understanding rather than the user having to fit the voice communication artificially into some predetermined structure.

The navigation of the recording is made easy and fast by simple referral to the inserted tags whose meanings will either be known to the user or can be presented at the time of playback.

The method may further comprise one of the individuals selecting the one or more tags from a predetermined plurality of different types of tags, each tag having a different meaning. The advantage of using tags with different meanings is that the time taken to find a particular type of information, such as an address or telephone number, from within the recording is much reduced. This also provides a far more useful system as it accommodates the many different classes of significance that typically occur within a single voice communication recording.

For example, tags of different classes may be used to represent the following:

action; something that a participant in the conversation needs to do after the conversation has ended.

note of information; a phone number, real or email address, URL.

relevant discussion; a section of the recording that is an argument or discussion, the progress or course of which is interesting.

a point that needs further research; e.g., an assumption made that should be checked out.

a point to be forwarded; namely that should be passed to someone not present at the meeting.

agenda items (and other natural divisions).

attendance points; points where people entered or left the meeting.

change action; change of slide or page in associated presentation materials.

Also as different types of tags may have different values associated with them, the importance of different parts of the recording can be analysed either manually by viewing a graphical representation of the recording or automatically by a computer analysis being performed on the tags and recording.

Preferably, the association of at least one of the tags is performed while the voice communication is still proceeding. This has the advantage of saving overall time in the creation of a structured voice communication recording as the user does not have to return and listen to the communication again inserting tags at the appropriate points in the recording. Having said this, in some cases it will be necessary to insert tags after the recording has been made because it was not possible to do so during the recording. In these cases the present invention also has utility as the structured recording is often used subsequently by other users such as in the case of reporting of company results by telephone conference calls.

It is particularly advantageous if the locations where the messages or conversations are stored are readily accessible to multiple individuals (e.g. the individual(s) who recorded them, and/or other individuals), i.e. they are “shared”.

According to another aspect of the present invention there is provided a method of communicating a voice message from a first individual to a second individual, the method comprising: the first individual using a telephone communication device and a telecommunications network to transmit the voice message for the second individual to a storage location accessible at least by the second individual; the first individual or the second individual associating one or more tags, each selected from a plurality of predetermined different tag types, with selected respective points or portions within the recording, each tag being machine interpretable and indicating a meaning of the respective point or portion within the recording; and storing the tags in the location.

The advantage of this aspect of the present invention is that there is no need for there to be a conversation in real time between the two individuals. Rather, messages can be left for the recipient either in a tagged form or can be tagged at a later time.

Preferably, the association of tags with the points or portions within the recording is performed using at least one of the communication devices, the possible tags being associated with respective keys of that communication device and the tags being selected by selecting the respective keys. This is a convenient way of placing the user-defined structure within the recording which requires the use of no new or special equipment and which is inherently simple to use. It also makes easier the insertion of the tags in real time as the recording or transmitting step is being carried out, as the individual is inherently familiar with the command interface. Similarly, if the navigation of the tags at a later time is also carried out using the keys of the at least one communication device many of the above described benefits are also obtained.

The present invention also extends to a method of processing the recording produced by the above described method, the processing method including automatically locating the points or portions of the recording using the tags and processing the recording based on the meaning of the tags. The processing can be in many different forms from the editing out of a portion of the recording, the use of the inserted tags for pure navigation, analysing the different sections defined by the tags and displaying a visual representation of the voice communication.

The displaying of graphical information representing the recording and the tags, advantageously provides the user with a simple graphical interface from which editing the recording and using the inserted tags becomes easy and faster. This is particularly so if the displaying step comprises displaying a timeline of the recording with tags interspersed along the timeline. Further the use of icons representing events and articles associated with the portions of the recording adds another layer of information which assists in the fast editing and comprehension of the content of voice communication recordings.

The present invention also extends to a communication system for recording a voice communication, the system comprising: at least two telephone communication devices; a communication network for supporting communications between the communication devices; a recording device accessible using the communication devices, the recording device being arranged to record the voice communication between the communication devices; and means for associating one or more machine-readable navigation tags with selected respective point or portions within the voice communication recorded by the recording device.

Furthermore, the present invention can also be considered to reside in a communication system for recording a voice message, the system comprising: at least two telephone communication devices; a communication network for supporting communications between the communication devices; a recording device accessible using the communication devices, the recording device being arranged to record the voice message left by one of the communication devices for retrieval by another of the communication devices; and means for associating one or more machine-readable navigation tags with selected respective points or portions within the message recorded by the recording device, wherein each navigation tag is a selected one of a plurality of different types of navigation tags having different meanings.

The above described systems both benefit from the advantages described above in relation to the methods. The component parts of the systems are also subject of the present invention as is set out below.

According to another aspect of the present invention there is provided a user-operated telecommunications device for storing, playing back and editing voice communications, the device comprising: a data store; a data recorder for recording voice communications in the data store; means for inputting control signals into the device; and means for associating one or more machine-readable markers specified by the control signals, with selected respective points or portions within the voice communication recorded by the data recorder.

According to another aspect of the present invention there is provided a user-operated telecommunications device for playing back and/or editing a remotely stored voice communication recording, device comprising: means for inputting control signals into the device; means for associating one or more machine-readable markers, specified by the control signals, with selected respective points or portions within the voice communication recorded by the data recorder; and/or means for navigating through the voice communication recording using one or more machine-readable markers, as specified by the control signals, associated with selected respective points or portions within the voice communication recording. Here the tagging application is housed remotely, but the user can advantageously utilise their communications device to control playback and editing.

According to a final aspect of the present invention, there is provided a user-controlled recording device for storing, playing back and editing voice communications, the device comprising: a data store; a data recorder for recording voice communications in the data store; means for receiving control signals from remotely located users for storing, playing back and editing voice communications; and means for associating one or more machine-readable markers specified by the control signals, with selected respective points or portions within the message recorded by the recording device. Here the mobile telephone for example can be used to house the inventive recording and tagging application in an advantageous way which does not require login procedures for the operator of the telephone as is discussed later.

### BRIEF DESCRIPTION OF THE FIGURES

Non-limiting preferred embodiments of the invention will now be described, for the sake of example only, with reference to the following figures, in which:

FIG. 1 is a schematic diagram showing a voice recording system of a first embodiment of the present invention;

FIG. 2 is a block diagram showing the constituent elements of the computer system of FIG. 1;

FIG. 3 is a flow diagram showing a method of using the system of FIG. 1 in a voice recording phase;

FIG. 4 is a flow diagram showing a login procedure of the method shown in FIG. 3;

FIG. 5 is a flow diagram showing a method of using the system of FIG. 1 in a voice playback and editing phase;

FIGS. 6a and 6b are screen representations of a GUI implemented on a smart mobile phone having an integrated keypad and touch screen incorporating a timeline which can be used for the voice playback and editing phase;

FIGS. 7a and 7b are screen representations of a GUI implemented on a Personal Computer incorporating a timeline which can be used for the voice playback and editing phase; and

FIG. 8 shows a voice recording system of a second embodiment of the present invention.

### DETAILED DESCRIPTION OF THE PREFERRED EMBODIMENTS

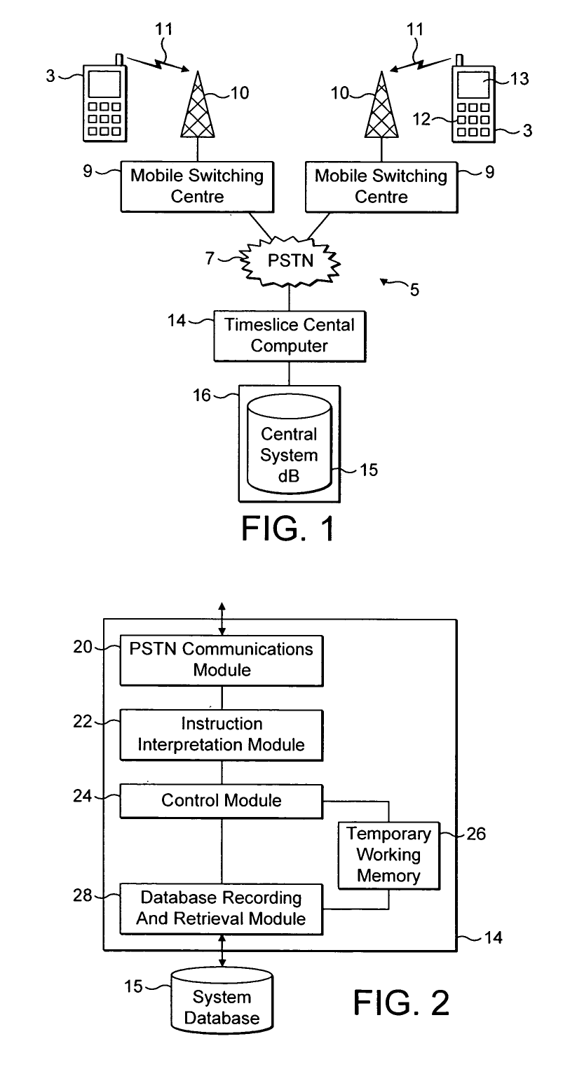

Referring to FIG. 1, a system for recording and playing back a free format telephone conversation between a first and second user according to a first presently preferred embodiment of the invention is now described. The system comprises first and second telephone communication devices 1, 3, which in this embodiment are mobile phones, but the present invention is not limited in this respect as is described later.

The two mobile phones 1, 3 communicate via a standard communication network 5, which may be of any form, but in the present embodiment is an existing public telephone system (Public Switched Telephone Network) 7 and mobile communications network including mobile switching centres 9, other exchanges (not shown) and transmitter/receiver beacons 10. The connections between the communication devices 1, 3 and the network 5 are indicated as lines 11, which in the present embodiment are wireless radio links. However, it is possible in other embodiments, not using wireless communication devices, for this connection to be made by fixed lines such as electrical cables or optical fibre, or equally any other known or future form.

Each mobile communication device 1, 3 in this embodiment has a keypad 12 and a graphics display screen 13 which are used as the communications control interface with the user. This interface is also used to control the operation of a TimeSlice central computer 14 as will be described below.

The communication network 5 is also connected to the abovementioned TimeSlice central computer 14 (e.g. server) having a storage facility 16 which stores a central system database 15. The central computer 14 is provided in this embodiment to act as a central recording and playback facility. Once made party to a conversation, the central computer 14 can record (digitally in this embodiment —though this could also be an analogue) or all or part of that conversation together with any tags which either of the parties to the conversation insert using their keypads 12 during the conversation. Tags having different meanings can be selected and inserted such that during the conversation navigation information is being entered into the recording. Subsequently, access to the central computer 14 enables playback of the recording, use of the inserted tags for rapid navigation and editing of the recorded message in various ways, and statistical analysis of the recording as will be elaborated on later.

The central system database 15 provided on the storage facility 16 not only stores the recordings and tags inserted by the users, but also account and login details of the users, as well as statistical analysis algorithms for inserted tag analysis as is described later.

Referring now to FIG. 2, the TimeSlice central computer 14 comprises a PSTN communications module 20 for handling all communications between the central computer 14 the PSTN 7 to the telecommunications devices 1,3. The implementation of the communications module 20 will be readily apparent to the skilled addressee as it involves use of a standard communications component.

The communications module 20 is connected to an instruction interpretation module 22 that interprets signals received from the mobile communications devices 1,3, in this embodiment DTMF audio signals, and converts them into digital signals having specific meanings (DTMF codes). Similarly, the interpretation module 22 also acts in reverse to generate DTMF audio signals from digital codes when these signals are to be transmitted back to the user as a representation of a specific tag having been encountered during the playback phase. It is to be appreciated that the interpretation module 22 can also act to convert tags to representations other than DTMF audio signal. The identifying technology used in the interpretation module 22 is well-known to the skilled addressee and so is not described herein.

The central computer 14 also comprises a control module 24 which is responsive to interpreted instructions received from either of the mobile communications devices 1,3 to control the recording, tag handling and playback operation of the central computer 14. The details of the functions will become apparent from the description later of the method of operation of the central computer in implementing the present invention. In order to carry out these functions, the control module 24 is connected to a temporary working memory 26 and a database recording and retrieval module 28. The temporary working memory 26 is used for recording conversations before they are stored in the database 15 and also for storing retrieved recordings for editing and playback purposes. The database recording and retrieval module 28 controls the access to the system database 15 in the permanent storage facility 16 and is comprised of conventional database management software and hardware. As such, further details of its construction will be readily apparent to the skilled addressee and are not provided herein.

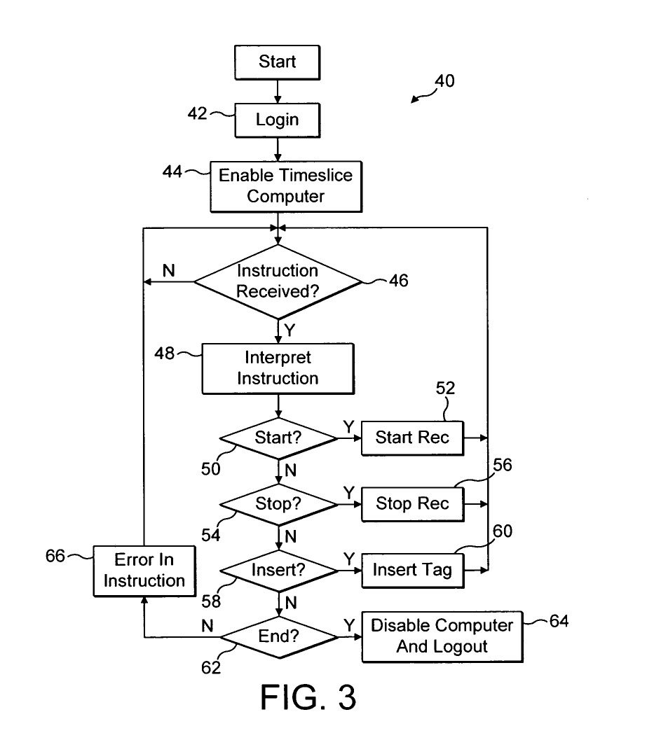

The present embodiment is used in two phases, the first being a recording phase 40 where the central computer is enabled and the telephone conversation is recorded together with any tags that the users may which to insert. The second phase is a playback and editing phase 90 where the recording is retrieved and played back using the inserted tags or is edited by inserting tags into the recording for subsequent improvements in navigation of the recording to extract relevant data. Both these phases are described below with reference to FIGS. 3, 4 and 5.

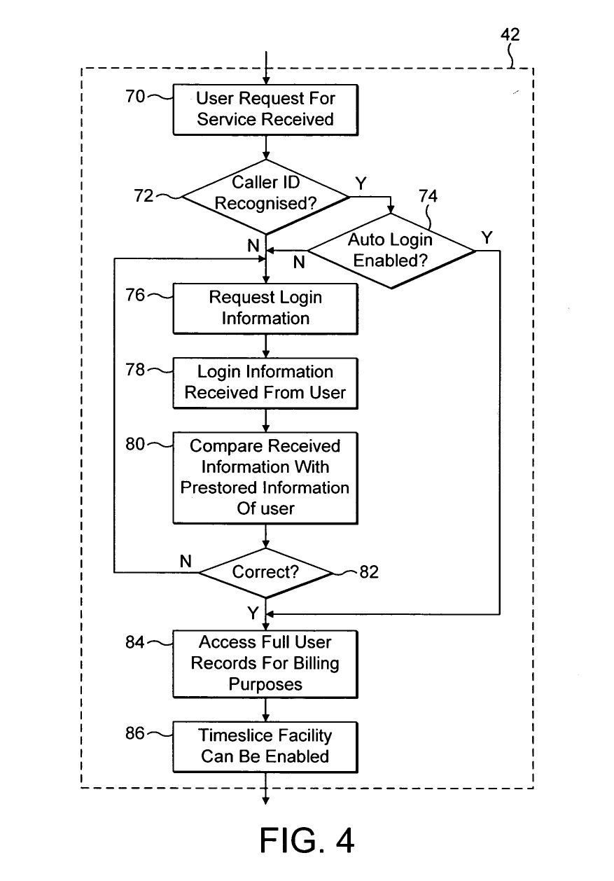

Referring now to FIG. 3, the recording phase 40 commences with a login procedure 42 of a conventional kind, namely an identity verification procedure of the user and/or the communications device 1,3. The login procedure 42 provides security for sensitive information which may be stored in the system database 15 and enables the person requesting the information to be identified for billing purposes. Only valid recognised users are permitted to use the central computer 14. The login procedure 42 can take any of a number of different forms but in the present embodiment two conventional but alternative techniques are used. The first is based on identification of unique caller identity and the second is based on a conventional predetermined password technique. Both these are described in detail later with reference to FIG. 4. The identification of the user(s) and/or device(s) to the central computer 14 may also include accessing an account for one or both of the users and/or devices maintained at the central computer 14.

Once the user has completed the login procedure 42, the recording phase 40 continues by enabling the TimeSlice central computer 14 at step 44. In the present embodiment, either user of the communication devices 1, 3 can choose whether or not to enable the central computer 14, that is to place the central computer 14 into a state in which it is party to the conversation. The enablement of the central computer 14 is usually carried out at the time when the conversation is initiated, typically by conferencing in the central computer 14 onto the telephone conversation as a third party. However, there is the option at any point during the conversation to enable the computer by sending the appropriate signals to connect to and login to the central computer 14. This would be by use of a Star Service (using Star key on keypad 12). By the entry of the appropriate key sequence during a call, the computer 14 is enabled. Regardless of when the computer is enabled, the PSTN communications module 20 handles the reception of the signals from either user regarding the setting up of a conference call to enable the computer 14 to listen in on the conversation.

Note that the central computer 14 can be configured such that it is enabled for all conversations (e.g. all conversations involving a given user), and/or that (e.g. as a default state) it is set to record all of each conversation for which it is linked in and enabled. This is described later with reference to the login step 42 of FIG. 4.

The central computer 14 is configured to play a warning message stating that the conversation is being recorded and also to record the playback of that warning message with the voice recording. The purpose of this is to address legal issues regarding recording of conversations.

When the central computer 14 is in its enabled state, the users are able to send instructions to the computer 14 to control what is recorded. This includes the real-time insertion of computer readable tags into a current voice recording. The recording phase 40 determines whether an instruction has been received at step 46 and on receipt of such an instruction, it is interpreted at step 48 by the instruction interpretation module 22. The received instruction can indicate to the central computer 14 which portion(s) of the telephone conversation it should record. For example, at any point in the conversation either of the users may be able to transmit a “start” instruction which is checked at step 50 and if recognised the recording of the telephone conversation is commenced at step 52. Users can also transmit a “stop” instruction to the central computer 14 which when checked at step 54 can result in termination of the recording at step 56. There is preferably no limit on the number of portions of telephone call the central computer 14 may record.

The computer is also configured on selection by two parties to make two separate recordings of the conversation. Each of these recordings may be made under the control of a respective one of the users, such that each user indicates to the central computer 14 which portions of the conversation to include in his own recording using his or her respective start/stop commands.

The other types of instruction which can be received during the recording phase 40 are insert tag instructions and these are checked at step 58. If an insert tag command is recognised, then the relevant tag is inserted or overlaid on the voice recording at step 60.

Optionally, either of the users can also disable the recording phase 40 at the central computer 14 at any time, so that it is not party to the conversation. Accordingly, the other type of valid command is an “end recording phase” instruction which is checked at step 62 and has the result of disabling the recording phase 40 on the central computer 14 and logging out the user at step 64. The receipt of any other command is considered to be an error at step 66 and as a result the user is given another chance to send a correct instruction.

The way in which the recording phase 40 is carried out subsequent to enablement is now described. The users of communication devices 1, 3 carry out a conversation. The central computer 14 receives the entire conversation, and stores a recording of it. In the case that the conversation includes video telephony, the recording can include a recording of the video portion as well as a recording of the audio (voice) portion. The recording is stored in the system database 15 by the central computer 14, in association with indexing data (not shown) including the received identity of the user(s) and/or the device(s) 1, 3. The indexing data further includes the time and date of the conversation as determined by the control module 22.

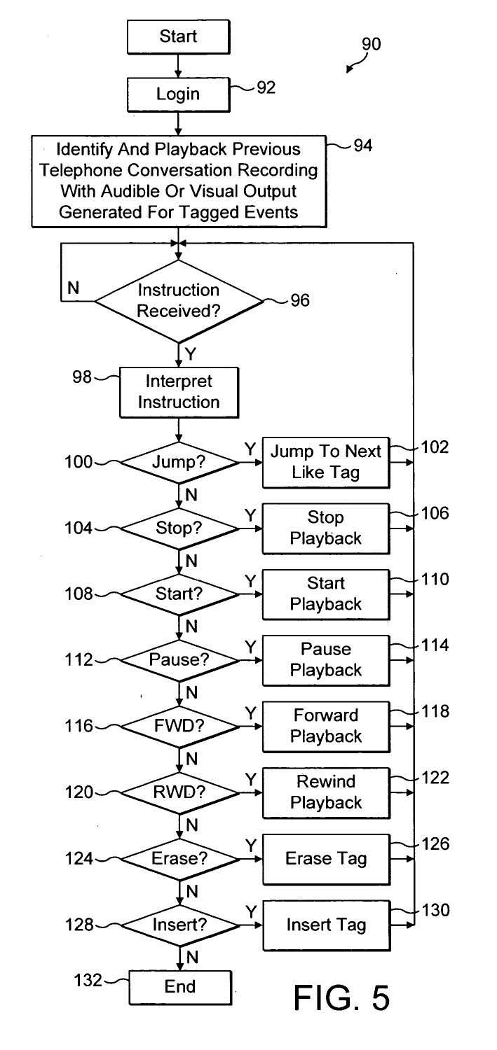

The central computer 14 is adapted to add one of a predetermined set of tags to the recording under the control of either or both of the users. That user, or those users, can control the central computer 14 to add those tags during the ongoing conversation (“on the fly”) as is described above. Alternatively or in addition, as is described later with reference to the playback and editing phase 90 of FIG. 5, after the conversation is finished (e.g. at a time when the user reconnects to the central computer 14, and completes an additional login (self-identification) procedure, before accessing the recording using the indexing data to identify it).

Each of the tags may be one audio tone, or a sequence of audio tones, inserted or overlaid onto the recording of the conversation. In the present embodiment, each audio tone is a DTMF code associated with a respective one of the keys of the keypads 12. A user can add a tag which is a single DTMF tone by keying the respective key, or a tag which is a plurality of tones by keying the corresponding sequence of tags.

Each tag is computer readable and has a respective meaning. The tags are identifiable automatically because of this by the interpretation module 22 (well-known technology exists to identify DTMF tones automatically). As will be described later, the users of devices 1, 3 (and/or anyone else having an access status recognised by the central computer) may extract the recording and replay it. At this stage, the information stored by the tags is of value.

Referring now to FIG. 4, the login step 42 is now described in greater detail. The login step 42 commences with the central computer 14 receiving at step 70 a user's request for the TimeSlice service. In the present embodiment, the caller ID attached to the request is analysed at step 72 to determine whether the caller ID is recognised. If recognised, then a check is made at step 74 to determine whether an automatic login procedure has previously been set up. This procedure makes the assumption that the anyone having the correct caller ID can be logged in without further checks being necessary and in particular that login steps 76 to 82 of the login core procedure are not necessary.

If the automated login procedure has not been enabled at step 74 or the called ID is not recognised at step 72, then the login core procedure commences. At step 76 the central computer 14 requests login information from the user or the communications device 1, 3. This may be anything from a secret code stored in the user's mobile phone SIM card to a PIN code memorised by the user. The request is sent back along the same channel from where the request came to the originating source, in this case one of the mobile communication devices 1, 3.

In response to this login information is received at step 78 from the user, and is compared at step 80 with pre-stored information of the user. This pre-stored information is typically retrieved from the central database 15 of the storage facility 16 in the format of a user record or a field of the user record. If at step 82 the result of the login comparison is that there is a correct match, then at step 84 access to full user records for the purposes of billing is enabled. Subsequently, at step 86 the TimeSlice facility provided by the central computer 14 can be enabled. However, if the login information is incorrect as determined at step 82, then the core login procedure returns to the beginning at step 76 and asks the user for their login information again. Whilst not shown in FIG. 4, the user would only be allowed to traverse this loop a few times before the login procedure would for security purposes prevent this user from accessing the services of the TimeSlice central computer 14.

Referring to FIG. 5, the basic procedure carried out by the playback and editing phase 90 is now described. The playback and editing phase 90 commences with a login procedure 92 that is identical to the login step 42 of the recording phase 40 described previously and shown in FIG. 4. Once the user has been identified, the records associated with that user are available and the user is presented with a list of the TimeSlice recordings which they have previously made. The user selects a recording and this is played back to him at step 94 on his communication device 1, 3. Each of the tags which have previously been entered (if any) are represented on the played back recording as audible outputs and/or visual outputs on the screen 13 of the communication device 1, 3. At this stage, the user can interact with the recording which is being played back using the keypad 12 of the communication device 1, 3. In particular, the user can both navigate through the recording using the tags or can edit the recording by adding/deleting tags. More specifically, the central computer 14 keeps checking at step 96 to determine whether an instruction has been received. Once it has been received, it is interpreted at step 98 by the instruction interpretation module 22 an appropriate action is taken in consequence. The basic navigation instructions of stop, start, pause, forward, rewind are checked at steps 104, 108, 112, 116 and 120. The appropriate navigation of the recording namely to stop, start, pause, forward and rewind the playback at steps 106, 110, 114, 118 and 122 can be carried out using these basic conventional commands.

In addition instructions relating to navigation and editing using inserted tags can also be carried out. Namely if a ‘Jump’ command is detected at step 100, the control module 24 moves at step 102 the current point of the playback to the next corresponding tag. It is to be appreciated that as many different types of tags can be inserted, the Jump command is specific for a particular type of tag. With an understanding of what different tags mean this is a very powerful feature of the present invention in that the user can go precisely to the point of the recording which is of interest and importance to the user without having to listen to most of the recording. Having said this, there can be a general Jump command provided which simply takes the playback to the next tag whatever its meaning.

Other tag related commands such as ‘erase tag’ and ‘insert tag’ which are checked and implemented at steps 124, 126 and 128, 130 respectively, enable a user to change the arrangement of tags which have been inserted in the recording during its recording or to add to tags after the recording to aid subsequent playback of the recording by the user or other users.

The sensing of instructions is carried out repeatedly for each received instruction until an ‘end playback and editing phase’ instruction is received, whereupon this phase is ended at step 132.

Whilst FIG. 5 shows the basic navigation functions of the playback and editing phase 90, there is no limit to the various types of instructions that can be generated by the user's control of the mobile communications device. Whilst these are too numerous to mention in this document, some idea of what can be achieved during this phase is described below. It is to be appreciated that the skilled addressee would have no difficulty in implementing these instructions using his knowledge.

When the recording is re-played using one of the mobile communication devices 1, 3, a message is displayed on the screen indicating the meaning of any tag which is encountered. Furthermore, when the recording is re-played, the mobile communication devices 1, 3 actually reproduce the tones using their sounders, so that the user may recognise their meanings for himself.

Some possible tags might have the respective meanings of (i) the beginning or (ii) the end of business negotiations, (iii) the beginning or (iv) the end of discussions concerning transport arrangements, etc. Other examples of possible tag meanings will be clear from other portions of the present text.

Furthermore, as mentioned previously any recording may be edited (within the central computer 14 and database 15, or after the recording has been extracted from the central computer 14, optionally leaving a copy of the recording there) based on the tags.

For example, the recording may be transformed into a second recording which, when played, omits sections delineated by pairs of the tags of certain type(s). This editing is preferably non-destructive, such that the portions of the first recording which are omitted when the second recording is played, are merely “hidden” and can be restored on demand.

In a further example, the tags may be used to enhance a presently existing editing technique, such as one which eliminates silences, or detects changes in the speaker. This may be done for arranging by the tags to have meanings associated with those functions, e.g. a tag indicating the start or end of a silence, or a tag indicating a change of speaker.

A further example is that the tags can be used collectively to generate further annotation. For example, the recording can be reviewed automatically to identify regions of interest or “value” based on the observation of predefined patterns of tag usage. For example, regions of the recording containing tags with a statistical frequency above a certain coefficient (or simply of higher than average statistical frequency) can be labelled as interesting. The very presence of certain sorts of tags may be enough to influence this annotation by “value”, e.g. there can be a tag meaning “high value” and/or a tag meaning “low value”. Therefore a varying parameter related to the density of tags with time during a recording can be assigned to the recording and this can be used to profile the recording to highlight areas of high entropy and importance. Certainly with long messages such analysis can be very helpful in finding relevant information quickly.

Note that, whereas tags are preferably associated with exact points in the recording, or portions of the recording with well-defined ends set by the tags, the “value” parameter may be defined continuously over some or all of the recording, for example varying according to the distance to the nearest tag(s) of certain type(s).

Subsequently, the editing procedures described above can be performed based on the assigned “value”. For example, passages of low value may be omitted or hidden, and/or passages of high value may be transmitted to specified individuals. Furthermore, portions of high “value” may be stored (e.g. in the central computer 14) at a preferential compression rate, or selected for automatic summarisation.

Note that the editing procedure may include automatically removing some or all of the tags (e.g. the tags of given type(s)).

Preferably, the annotated recordings created by the first embodiment can be forwarded to other individuals, or portions of them defined by the tags may be forwarded.

Although the present embodiment of the invention has been explained above in relation to a conversation, any recording may also be a message left in the central computer 14 by a single user with the tags (added at the time or subsequently) providing annotations of the messages. The messages are for subsequent retrieval by one or more other users specified by data associated with the message. For example, the owner of communication device 1 may access the central computer 14 and leave a message annotated with tags of a plurality of types for subsequent retrieval by the owner of communication device 3.

It is particularly convenient if the central computer 14 and the associated storage 16 are provided as part of a system, such as the exchange of a telephone network, which also stores messages without tags, and conventional e-mail messages.

The central computer 14 of the present embodiment is arranged to be accessible by users (with appropriate access status) not only via mobile telephones but also using computers such as PCs accessing the PSTN 7. More generally, the access to the central computer 14 may be using browser software where there is an Internet capability of the central computer 14.

Any device having a screen (e.g. the PC or the phones 1, 3) may also be able to access the central computer 14 and see a visual representation of a given recording, for example as a timeline having icons of types corresponding to the types of respective tags. The icons are in an order corresponding to the order of the corresponding tags in the recording. They may be equally spaced along the timeline, or be at locations along the timeline spaced corresponding to the spacing of the corresponding tags in the recording.

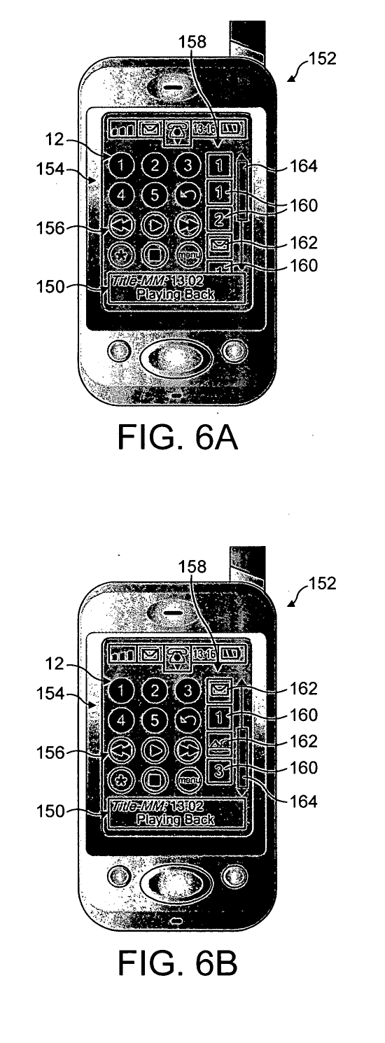

FIGS. 6a and 6b show a Graphical User Interface (GUI) 150 on a smart mobile phone device 152 which can be used as part of an alternative embodiment of the present invention. The GUI 150 shown in FIG. 6a illustrates how the keypad 12 can be utilised as a playback navigation control interface. Here the keys ‘1’ to ‘5’ 154 represent respective tags 1 to 5 each having a different meaning. Keys ‘6’ to ‘0’ 156 represent the functions ‘revert’, ‘rewind’, ‘play’ ‘forward’ and ‘stop’ respectively, with the ‘play’ key becoming a ‘pause’ key once the recording is playing. The GUI has a timeline 158 which displays tags 160 and events 162 in order of their occurrence during the voice recording. As the time line is too large to show completely on the screen at one time, a scroll bar 164 is provided. FIG. 6a shows the scroll bar in one position and FIG. 6b shows it in another, with the subsequent change of displayed tag and event icons 160, 162. Event icons 162, in this case, are icons representing the arrival of a mail during the recording or a picture message, however any event, function or article relevant to that part of the recording could be represented, such as an attachment which should be viewed at that time in the recording. In this way, the user can see at a glance what types of information are contained in a recording without even having to listen to it.

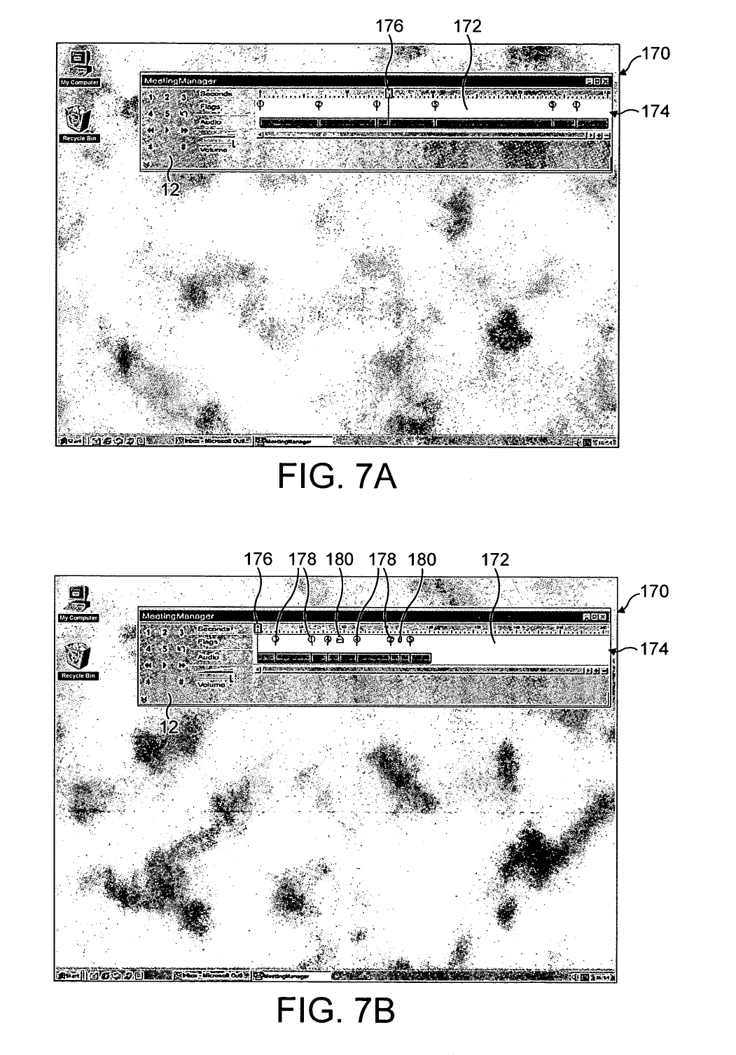

Referring now to FIGS. 7a and 7b, another GUI 170 this time on a PC which is used as part of another alternative embodiment of the present invention is shown. The GUI 170 shown in FIG. 7a is similar to that described previously in that it has a control key pad 12 and a timeline representation 172. However, in this GUI 170 the timeline 174 is a scaled in seconds and includes a time marker 176 which runs along the timeline 174 as the recording is being played back. Tag markers 178 are provided along the timeline which correspond to keys 1 to 5 as in the previous GUI 152. As can be seen in FIG. 7b, in another recording event markers 180 are provided to represent, in this case the arrival of an e-mail and an attachment to a portion of the voice recording which needs to be considered.

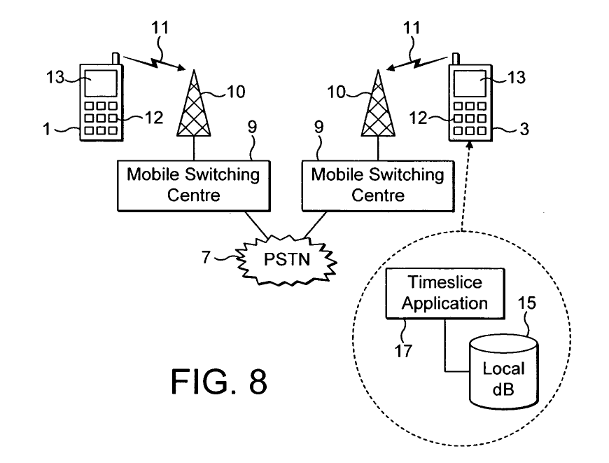

A further embodiment of the present invention is now described with reference to FIG. 8. This embodiment is very similar to the first embodiment and so to avoid unnecessary repetition only the differences between the two embodiments are described hereinafter. Whereas in the first embodiment, the central computer 14 was not especially associated with either of the users (but rather had its own operator, such as the operator of the network 5), in the embodiment of FIG. 8, the TimeSlice computer 17 is actually a software application running on and associated with the communication device 3. In this way, the local TimeSlice computer 17 can be considered to be physically part of the communication device 3.

Accordingly, the user of the mobile communications device 3 does not need to go through any login procedures, though any other user connecting to the TimeSlice local computer 17 on the communications device 3, would need to identify themselves as an authorised user of the computer 17 as before.

The issue of conferencing in the central computer 14 in the first embodiment is not an issue now as any calls to or from the communications device 3 can be recorded at the communication device 3.

Note that in the case described above in which the communication device 1 is part of a communication network 5 including a mobile switching centre 9 which communicates with the PSTN 7, the local TimeSlice computer 17 can alternatively be connected to the mobile switching centre 9 associated with the communications device 1.

In the above described embodiments the user has had, at the time they are playing back the recording, the option of editing the recording or tags within the recording. However, it is also possible in alternative embodiments for an individual to only have access to the payback facilities of the computer and not the editing facilities. This is useful in situations where the user commands are to be simplified and/or when the recording annotated with tags is only to be editable by authorised individuals.

Examples of use of the Present Embodiments

Two scenarios are now described in which embodiments of the present invention are used. In the following description the reference numerals used are those of the first embodiment of the present invention, but the second embodiment would also be suitable.

In both of the following examples it is assumed that the caller activates the system by either conferencing in the central computer 14 or using Star Services. It is also assumed that the automatic login procedure described with reference to FIG. 4 has been implemented such that a caller ID from a mobile telephone is sufficient to enable a user of that mobile telephone to login. In these cases, whilst it has not been described, the user will have previously set up the central computer 14 to do this. As will be seen in the second example, were a user wishes to access another user's TimeSlice recordings, the conventional password or PIN number is required.

A first scenario concerns an individual Andrea, the owner of mobile telephone 1, who is working away from her office. Andrea checks her e-mails using a PC, and finds that an individual Paul has sent Andrea three annotated phone conversations created by the first embodiment of the present invention. Andrea skims through the conversations she has been sent using a PC navigation GUI 170 shown in FIGS. 7a and 7b.

The next day, she uses her mobile phone 1 to call the Los Angeles Police Department to arrange for two officers to marshal traffic at a location the following week. During the conversation, which is recorded by the central computer 14, she is given a reference number and a contact phone number, together with a list of details to get back with. She flags all these points on the fly by pressing keys 13 (which adds DTMF tones to the recording) and saves the conversation in the system database 15 via the central computer 14. The tags may be tags which specify that a phone number is present, or alternatively tags which do not have this specific meaning.

She then uses her phone 1, calls up the tourist office at Big Sur and gets a list of hotels in the area. As she talks, she uses the keys 12 to signal to the central computer 14 to flag the phone numbers of several suitable hotels.

She then contacts the computer 14 directly (which may be done simply by phoning a certain number) and leaves a short message on the central computer 14 to be read by another individual Duncan. This message is attached to an annotated copy of a phone conversation she had with the client, and forwarded to Duncan. She labels one short portion of the message as particularly important, by placing respective kinds of tags at either end of it.

Andrea remembers a previous conversation with a colleague about restaurants. She accesses the conversation by connecting to the central computer 14 on her mobile telephone 1 and using the GUI and the DTMF tones to control playback, skips to a point tagged with a tag associated with “entertainment”, where a certain restaurant was mentioned. She notes the phone number then makes a reservation for that night.

After dinner, Andrea spends 30 minutes editing her files of phone conversations. She does this by connecting to the system and going through and inserting respective kinds of tags to indicate portions of different meanings, automatically determining the interest value at each point, and then automatically erasing the parts for which the value indicates that they are of little interest. She copies several phone numbers into her SIM card. Finally, she calls her mother for a chat which again she records on the system. Her mother gives Andrea her brother's temporary address, which Andrea flags within the record of the call stored on the central computer 14.

The second scenario concerns an individual Duncan.

On a given day, Duncan uses his telephone 1 to assess the central computer 14, and using his mobile telephone GUI 150 together with DTMF tones generated by key presses, he skims through a message left by Andrea the previous day. It contains an annotated conversation with a client showing disagreement over the job budget. Duncan needs to follow this problem up.

His assistant Paul accesses the central computer 14, goes through the history of communications with the client, and sets up a meeting for that afternoon. Paul copies Duncan the relevant correspondence, e-mails and a phone message containing several forwarded audio clips from the central computer 14.

When Duncan skims through the clips using the tags as reference points, he finds confirmation of the terms that were agreed on Andrea's budget. Duncan asks Paul to record and annotate the meeting using his local microphone recording device and his mobile phone 3 to transfer the recording of the meeting made by the microphone recording device to the central computer 14.

Duncan has an important meeting at 11.00 AM with a potential client. To help prepare for this, Paul has accessed an audio file stored in the central computer 14 in which Andrea makes a presentation to a different client.

He also forwards one of the files to the mobile phone of the first client. The first client listens to the presentation and agrees he would like Andrea to be part of a project they are collaborating on.

Duncan then has a meeting with the first client to discuss the budget. Duncan reminds the client of various items of correspondence, and clears up any ambiguity by playing an audio clip that Paul has retrieved from the central computer 14 earlier.

Before going to bed, to remain on top of a scheduling problem, Duncan leaves a message to himself on the central computer 14 in the form of a long, annotated list of urgent actions, each given a tag of a sort indicating its importance level. He forwards a copy to the voicemail of Paul's mobile phone.

The next day, Duncan has a meeting at a client's office in San Francisco. Duncan knows that the central computer 14 is storing some records of the early brainstorming sessions. Paul had recorded and annotated these sessions. Duncan refers to his diary to find the date and time of these sessions. With this information he can locate the relevant recordings by accessing the central computer 14 on his colleague's mobile phone. To access the central computer 14, he enters his user-name and password then locates the recordings, one by one. He skims through the first session, jumping from tag to tag until he finds a ‘magic moment’.

It is to be appreciated that in the above described embodiments and examples, the telecommunication devices are mobile telephones. However, the present invention is not limited to such devices, and is applicable to any telephone devices, including video telephones in which the screen of the communication devices includes an image of the user of the second telephone communication device. Alternatively, they may be computer apparatus such as PCs or Net terminals with a microphone and telephone compatibility.

In addition, the telephone devices may be any future system which transmits in addition to a voice signal (and optionally video signal) other data, e.g. streamed with the voice signal. For example, the other data may be text words, such as words which visually represent what either individual says.

Furthermore, it is to be appreciated that it is not necessary that both of the “users” of devices 1, 3 in the above-described embodiments are human. Rather, the present invention can usefully be employed when one of users is a machine, generating machine-generated voice signals (e.g. computationally or by playing a predetermined recording) operating a telephone device which is simply an interface between the machine and the communication network. In this case the “conversation or voice communication” between the users may have little or no information passed from the human user: it may for example consist of the human user phoning the machine to establish the communication and then annotating sounds automatically generated by the machine.

1. A method of recording and replaying at least part of a voice communication between two individuals, at least one individual using a portable mobile telecommunications device for the voice communication, the method comprising:
recording at least part of the voice communication;
associating one or more tags with selected respective points or portions within the recording, each tag being machine interpretable and indicating a meaning of the respective point or portion within the recording;
storing the recording and tags in a location accessible by the at least one individual;
accessing the stored recording and tags;
navigating through the recording to a point or portion of interest, as indicated by one or more of the tags; and
replaying the point or portion of interest of the recording,
wherein the associating, accessing, navigating and replaying steps are carried out under the control of the at least one individual by inputting data into their portable mobile telecommunications device.

2. A method according to claim 1, wherein the associating step further comprises selecting the one or more tags to be associated with selected points or portions within the recording from a predetermined plurality of different types of tags, each tag having a different meaning.

3. A method according to claim 1, wherein the storing step comprises storing the recording and tags in a location accessible to both of the two individuals.

4. A method according to claim 1, wherein the storing step comprises storing the recording and tags in a location accessible to individuals other than the two individuals.

5. A method according to claim 1, wherein the method further comprises generating voice signals automatically within the voice communication using a machine as one of the individuals.

6. A method according to claim 1, wherein the associating step comprises associating at least one of the tags while the voice communication is still proceeding.

7. A method of communicating a voice message from a first individual to a second individual, each individual using a telecommunications device to communicate the voice message and the telecommunications device of at least the second individual comprising a portable mobile telecommunications device, the method comprising:
transmitting the voice message for the second individual via a telecommunications network to a storage location accessible by at least the second individual and storing the voice message as a recording;
associating one or more tags, each selected from a plurality of predetermined different tag types, with selected respective points or portions within the recording, each tag being machine interpretable and indicating a meaning of the respective point or portion within the recording;
storing the tags in the storage location together with the recording;
accessing the recording and tags;
navigating through the recording to a point or portion of interest, as indicated by one or more of the tags; and
replaying the point or portion of interest of the recording,
wherein the associating step is carried out under the control of either the first or the second individual using their respective telecommunications device; and
the accessing, navigating and replaying steps are carried out under the control of the second individual by inputting data into their mobile telecommunications device.

8. A method according to claim 7, wherein the transmitting step comprises transmitting a pre-recorded voice message for the second individual.

9. A method according to claim 7, wherein the method further comprises generating voice signals automatically within the voice message using a machine as the first individual.

10. A method according to claim 1, wherein the associating, accessing, navigating and replaying steps are carried out by using a key pad of the respective telecommunications device.

11. A method according to claim 10, wherein the associating step comprises selecting a tag by pressing a key on the key pad, the possible tags being associated with respective keys of the key pad.

12. A method according to claim 11, wherein the navigating step comprises navigating to tags at different positions within the recording by asserting the keys associated with the respective tags.

13. A method according to claim 1, wherein the associating, accessing, navigating and replaying steps are carried out by using voice recognition software to process oral commands.

14. A method according to claim 1, wherein the associating step comprises associating one or more DTMF tones with an audio track recording.

15. A method according to claim 7, wherein the associating step comprises associating one or more tags with the voice message during the transmitting step.

16. A method according to claim 1, wherein the navigating step comprises locating automatically the points or portions of the recording using the tags and the method further comprises processing the recording based on the meaning of the tags.

17. A method according to claim 16, wherein the processing step comprises selecting at least one segment of the recording based on the tags and generating an edited version of the recording including or excluding the at least one segment.

18. A method according to claim 16, wherein the processing step comprises determining, for differing sections of the recording, differing values of an interest parameter indicating the interest of those sections of the recording using the tags.

19. A method according to claim 1, wherein the navigating step further comprises displaying a visual representation of the recording including symbols indicating locations of the tags within the recording.

20. A method according to claim 19, wherein the displaying step comprises displaying a visual representation which includes a timeline.

21. A method according to claim 19, wherein the displaying step comprises displaying a visual representation of the recording which includes icons representing events or articles associated with points or portions of the recording.

22. A communication system for recording and replaying at least part of a voice communication between two individuals, the system comprising:
at least two telecommunications devices, one of which comprises a portable mobile telecommunications device;
a communication network for supporting communications between the telecommunications devices;
a recording device accessible using the telecommunications devices, the recording device being arranged to record at least part of the voice communication between the telecommunications devices;
tagging means for associating one or more machine-readable navigation tags with selected respective point or portions within the voice communication recorded by the recording device;
navigation means for navigating through the recording to a point or portion of interest, as indicated by one or more of the tags; and
playback means for replaying the point or portion of interest of the recording,
wherein the tagging means, navigation means and playback means are all arranged to be controllable by the portable mobile telecommunications device.

23. A communication system according to claim 22, wherein the recording device is associated with an operator of the communication network and is located remotely from the telecommunications devices.

24. A communication system according to claim 22, wherein the recording device is associated with the mobile portable telecommunications device and is proximate or connected to the mobile portable telecommunications device.

25. A communication system according to claim 22, wherein the telecommunications devices comprise video telephone devices.

26. A user-operated portable mobile telecommunications device for recording, storing and playing back communications, the device comprising:
a data store;
a data recorder for recording voice communications into the data store,
input means for inputting control signals into the device;
marking means for associating one or more machine-readable markers specified by the control signals, with selected respective points or portions within the voice communication recorded by the data recorder;
navigation means for navigating through the voice communication recorded by the data recorder to a point or portion of interest as indicated by one of the machine-readable markers; and
playback means for replaying the point or portion of interest.

27. A device according to claim 26, wherein the navigation system is controlled by control signals specified by the input means under user control.

28. A device according to claim 26, further comprising editing means for editing points or portions of interest as indicated by the machine readable markers.

29. A device according to claim 26, wherein each marker is a selected marker from a plurality of different types of marker, each type having a different meaning.

30. A user-operated portable mobile telecommunications device for playing back and editing a remotely stored voice communication recording, the device comprising:
input means for inputting control signals into the device;
marking means for associating one or more machine-readable markers, specified by the control signals, with selected respective points or portions within the voice communication recorded by the data recorder;
navigation means for navigating through the voice communication recording using one or more machine-readable markers, as specified by the control signals, associated with selected respective points or portions within the voice communication recording;
playback means for replaying a point or portion of interest; and
editing means for editing points or portions of interest within the recording as indicated by the machine-readable markers.

31. A user-controlled recording device for storing, playing back and editing voice communications, the device comprising:
a data store;
a data recorder for recording voice communications in the data store,
means for receiving control signals from remotely located users for storing, playing back and editing voice communications; and
means for associating one or more machine-readable markers specified by the control signals, with selected respective points or portions within the message recorded by the recording device.

32. A method according to claim 2, wherein the storing step comprises storing the recording and tags in a location accessible to both of the two individuals.

33. A method according to claim 2, wherein the storing step comprises storing the recording and tags in a location accessible to individuals other than the two individuals.

34. A method according to claim 2, wherein the associating step comprises associating at least one of the tags while the voice communication is still proceeding.

35. A method according to claim 2, wherein the associating, accessing, navigating and replaying steps are carried out by using a key pad of the respective telecommunications device and the associating step comprises selecting a tag by pressing a key on the key pad, the possible tags being associated with respective keys of the key pad.

36. A method according to claim 35, wherein the navigating step comprises navigating to tags at different positions within the recording by asserting the keys associated with the respective tags.

37. A method according to claim 2, wherein the navigating step comprises locating automatically the points or portions of the recording using the tags and the method further comprises processing the recording based on the meaning of the tags.

38. A method according to claim 37, wherein the processing step comprises determining, for differing sections of the recording, differing values of an interest parameter indicating the interest of those sections of the recording using the tags.

39. A method according to claim 2, wherein the navigating step further comprises displaying a visual representation of the recording including symbols indicating locations of the tags within the recording.

40. A method according to claim 7, wherein the associating, accessing, navigating and replaying steps are carried out by using a key pad of the respective telecommunications device.

41. A method according to claim 40, wherein the associating step comprises selecting a tag by pressing a key on the key pad, the possible tags being associated with respective keys of the key pad.

42. A method according to claim 41, wherein the navigating step comprises navigating to tags at different positions within the recording by asserting the keys associated with the respective tags.

43. A method according to claim 7, wherein the associating, accessing, navigating and replaying steps are carried out by using voice recognition software to process oral commands.

44. A method according to claim 7, wherein the associating step comprises associating one or more DTMF tones with an audio track recording.

45. A method according to claim 7, wherein the navigating step comprises locating automatically the points or portions of the recording using the tags and the method further comprises processing the recording based on the meaning of the tags.

46. A method according to claim 45, wherein the processing step comprises selecting at least one segment of the recording based on the tags and generating an edited version of the recording including or excluding the at least one segment.

47. A method according to claim 45, wherein the processing step comprises determining, for differing sections of the recording, differing values of an interest parameter indicating the interest of those sections of the recording using the tags.

48. A method according to claim 7, wherein the navigating step further comprises displaying a visual representation of the recording including symbols indicating locations of the tags within the recording.

49. A method according to claim 48, wherein the displaying step comprises displaying a visual representation which includes a timeline.

50. A method according to claim 48, wherein the displaying step comprises displaying a visual representation of the recording which includes icons representing events or articles associated with points or portions of the recording.

51. A method of recording and replaying at least part of a voice communication between two individuals, at least one individual using a portable mobile telecommunications device for the voice communication, the method comprising:
recording at least part of the voice communication;
associating one or more tags with selected respective points or portions within the recording, each tag being machine interpretable and indicating a meaning of the respective point or portion within the recording;
storing the recording and tags in a location accessible by the at least one individual;
accessing the stored recording and tags;
navigating through the recording to a point or portion of interest, as indicated by one or more of the tags; and
replaying the point or portion of interest of the recording,
wherein:
the associating, accessing, navigating and replaying steps are carried out under the control of the at least one individual by inputting data into their portable mobile telecommunications device by using a key pad of the telecommunications device; and
the associating step further comprises selecting the one or more tags to be associated with selected points or portions within the recording from a predetermined plurality of different types of tags by pressing a key on the key pad, each tag having a different meaning and being associated with a respective key of the key pad, and associating at least one of the tags while the voice communication is still proceeding.

52. A method of recording and replaying at least part of a voice communication between two individuals, at least one individual using a portable mobile telecommunications device for the voice communication, the method comprising:
recording at least part of the voice communication;
associating one or more tags with selected respective points or portions within the recording, each tag being machine interpretable and indicating a meaning of the respective point or portion within the recording;
storing the recording and tags in a location accessible by the at least one individual;
accessing the stored recording and tags;
navigating through the recording to a point or portion of interest, as indicated by one or more of the tags; and
replaying the point or portion of interest of the recording,
wherein:
the associating, accessing, navigating and replaying steps are carried out under the control of the at least one individual by inputting data into their portable mobile telecommunications device by using a key pad of the telecommunications device;
the navigating step comprises locating automatically the points or portions of the recording using the tags and the method further comprises processing the recording based on the meaning of the tags; and
the processing step comprises selecting at least one segment of the recording based on the tags and generating an edited version of the recording including or excluding the at least one segment.

53. A user-operated portable mobile telecommunications device for recording, storing and playing back communications, the device comprising:
a data store;
a data recorder for recording voice communications into the data store,
a key pad for inputting control signals into the device;
an instruction interpretation module for associating one or more machine-readable markers specified by the control signals, with selected respective points or portions within the voice communication recorded by the data recorder;
a control module for navigating through the voice communication recorded by the data recorder to a point or portion of interest as indicated by one of the machine-readable markers; and
a database recording and retrieval module for replaying the point or portion of interest.

54. A user-operated portable mobile telecommunications device for playing back and editing a remotely stored voice communication recording, the device comprising:
a key pad for inputting control signals into the device;
an instruction interpretation module for associating one or more machine-readable markers, specified by the control signals, with selected respective points or portions within the voice communication recorded by the data recorder;
a control module for navigating through the voice communication recording using one or more machine-readable markers, as specified by the control signals, associated with selected respective points or portions within the voice communication recording;
a database recording and retrieval module for replaying a point or portion of interest; and
an editor for editing points or portions of interest within the recording as indicated by the machine-readable markers.

55. A user-controlled recording device for storing, playing back and editing voice communications, the device comprising:
a data store;
a data recorder for recording voice communications in the data store,
a communications module for receiving control signals from remotely located users for storing, playing back and editing voice communications; and
an instruction interpretation module for associating one or more machine-readable markers specified by the control signals, with selected respective points or portions within the message recorded by the recording device.
